(19) United States
(12) Patent Application Publication
(10) Pub. No.: US 2026/0152436 A1
(43) Pub. Date: Jun. 4, 2026

(54) NON-HYDRAULICALLY REACTIVE PARTICULATE MINERAL COMPOSITIONS FOR REDUCING CEMENT CONTENT IN CONCRETE

(71) Applicant: ROMAN CEMENT, LLC, Salt Lake City, UT (US)

(72) Inventor: John M. Guynn, Salt Lake City, UT (US)

(21) Appl. No.: 19/464,012

(22) Filed: Jan. 29, 2026

Related U.S. Application Data
(63) Continuation-in-part of application No. 19/096,059, filed on Mar. 31, 2025, now Pat. No. 12,540,101.
Application No. 19/096,059 is a continuation-in-part of application No. 18/242,445, filed on Sep. 5, 2023, now Pat. No. 12,435,000.
Application No. 18/242,445 is a continuation-in-part of application No. 18/961,356, filed on Nov. 26, 2024.

(51) Int. Cl. C04B 7/13; C04B 7/14; C04B 14/00; C04B 40/00; C04B 103/00; C04B 111/10

(52) U.S. Cl. CPC C04B 7/13; C04B 7/14; C04B 14/00; C04B 40/0028; C04B 2103/0088; C04B 2111/1037; C04B 2111/1087

(57) ABSTRACT

Non-hydraulically reactive blended particulate compositions for use in making low carbon blended cement or low carbon concrete include a pozzolanic component having a first D90 and a mineral filler component having a second D90 greater than the first D90 dry blended without intergrinding, wherein the composition is free of hydraulic cement. The pozzolanic component can have a D90 less about 45 μm and the mineral filler can have a D90 greater than about 45 μm. The pozzolanic material can be fly ash, bottom ash, metallurgical slag, silica fume, metakaolin, volcanic ash, natural pozzolan, calcined shale, calcined clay, and/or ground glass. The mineral filler component can be aggregate fines, quarry fines, limestone powder, granite fines, stone dust, rock dust, marble dust, mine tailings, pulverized bottom ash, pulverized metallurgical slag, ground recycled concrete, pulverized shale from shale oil extraction, or pulverized sand from tar sand extraction.

### CROSS-REFERENCE TO RELATED APPLICATIONS

This Application is a continuation-in-part of U.S. patent application Ser. No. 19/096,059, filed Mar. 31, 2025, which is a continuation-in-part of U.S. patent application Ser. No. 18/242,445, filed Sep. 5, 2023, and a continuation-in-part of U.S. patent application Ser. No. 18/961,356, filed Nov. 26, 2024, which are incorporated by references in their entirety.

### BACKGROUND OF THE INVENTION

### 1. Field of the Invention

The invention is generally in the field of supplementary cementitious materials (SCMs) and mineral fillers for use as substitutes for hydraulic cement in concrete.

### 2. Relevant Technology

Portland cement, sometimes referred to “OPC” (or “ordinary Portland cement”), is the most expensive component of concrete and is responsible for substantially all of the embodied carbon in concrete. The manufacture of cement clinker is responsible for an estimated 6-8% of all anthropogenic CO₂. There is a long-felt but unmet need to reduce cement clinker (“clinker”) consumption.

Supplementary cementitious materials (“SCMs”), such as fly ash, slag, and natural pozzolans, and mineral fillers such as limestone are often used to replace a portion of Portland cement in concrete. SCMs can yield improved concrete with higher durability, lower chloride permeability, reduced creep, increased resistance to chemical attack, lower cost, and reduced environmental impact. Pozzolans react with calcium hydroxide released during cement hydration. Limestone can provide nucleation sites that can promote cement hydration and a filler effect to improve paste density.

Cement producers typically make blended cements by intergrinding cement clinker with SCMs and gypsum. While intergrinding is an efficient and cost-effective way to make blended cements, it is impossible to control the particle sizes of the individual components. And such blends are hydraulically reactive, sensitive to moisture, and therefore have limited shelf life unless stored in a way that prevents contact with moisture or humid air. Unless blended cements are stored in a completely airtight environment, they will absorb moisture from the air and lose reactivity over time.

### SUMMARY

Disclosed herein are non-hydraulically reactive particulate mineral compositions for use in making low carbon blended cements and low carbon concrete mixes. The particulate mineral compositions comprise one or more pozzolanic materials and one or more mineral filler materials. Because the particulate mineral compositions are made so as to not be significantly hydraulically reactive, they do not lose their beneficial characteristics when exposed to moisture and humidity. As a result, they have essentially limitless shelf life. This permits them to be stored in silos essentially indefinitely until added to concrete as a blended SCM or blended with hydraulic cement to form a blended cement.

The particulate mineral compositions can be particle size optimized relative to each other and/or hydraulic cement when making concrete or blended cement in order to maximize the relative contributions of each component, with the pozzolanic component advantageously being relative fine to increase or maximize pozzolanic reactivity and the mineral filler component being relatively coarse to reduce or minimize water demand while increasing the particle packing density of the particulate components when blended with water to form cement paste. In some embodiments, the pozzolanic component can have greater fineness and/or lower D90 than ordinary Portland cement (OPC) or ordinary blended cement (OBC) formed by intergrinding cement clinker and one or more mineral additives, and the mineral filler component can have a lower fineness and/or higher D90 than OPC and OBC. The result is a cement paste that is optimized relative to the strength, water demand, particle packing density, and other physical and performance criteria.

Advantageously, the pozzolanic and mineral filler components are separately ground, classified, or otherwise processed to a desired particle size, particle size distribution, and/or fineness and then blended together without intergrinding. This preserves the particle size, particle size distribution, and/or fineness of the pozzolanic component and mineral filler component. In some embodiments, a plurality of pozzolanic materials can be interground to form a blended pozzolanic component prior to being blended without intergrinding with the mineral filler component. Similarly, a plurality of mineral materials can be interground to form a blended mineral filler component prior to being blended without intergrinding with the pozzolanic component.

Most pozzolans, particularly those which do not contain significant quantities of free lime or reactive calcium, have greater reactivity (e.g., activity index) when ground more finely. Intergrinding a softer pozzolanic material with a harder pozzolanic material can increase the efficiency by which the softer pozzolanic material is ground to a high fineness. For example, a softer pozzolanic material (e.g., diatomite, calcined clay, perlite, vermiculite, zeolite, clinoptilolite, and the like) can be interground with a harder pozzolanic material (e.g., blast furnace slag, other metallurgical slags, pumice, volcanic ash, glass, and the like), or even a harder mineral material (e.g., limestone, quartz, granite, basalt, steel slag, and the like), prior to being blended without intergrinding with the mineral filler component to form a non-hydraulically reactive particulate mineral composition.

In preferred embodiments, the mineral filler component can have a D90 that is greater than the D90 of the pozzolanic component. In other embodiments, the mineral filler component can have a D90 that is the same or less than the D90 of the pozzolanic component. In some embodiments, the particulate mineral compositions can be free of plant-based materials so as to consist or consist essentially of only inorganic mineral-based components. In some embodiments, the particulate mineral compositions can include a relatively small quantity (e.g., less than 10%, 8%, 6%, 5%, 4%, 3%, 2%, or 1%) of supplemental lime and/or supplemental sulfate to provide calcium and/or sulfate, which can be blended without intergrinding with the pozzolanic and mineral filler components, and/or interground with the pozzolanic component and/or mineral filler component prior to blending the pozzolanic component and mineral filler component without intergrinding to form a particulate mineral composition.

In some embodiments, a low carbon blended cement composition can be manufactured by dry-blending, without intergrinding, a hydraulic cement (e.g., Portland cement, OPC, or OBG) and a non-hydraulically reactive particulate mineral composition. In this way the respective particle size and/or fineness of each of the hydraulic cement and the particulate mineral composition components can be preserved and therefore optimized compared to simply intergrinding cement clinker, pozzolanic material, and mineral filler. Thus, any of the methods disclosed herein for manufacturing non-hydraulically reactive particulate mineral compositions and low carbon blended cements is a substantial deviation from and improvement over conventional methods for making binary and ternary blended cements, in which all the components are interground, making it impossible to optimize the relative particle sizes of the different components.

These and other advantages and features of the invention will become more fully apparent from the following description and appended claims, or may be learned by the practice of the invention as set forth hereinafter.

### DETAILED DESCRIPTION

Disclosed herein are non-hydraulically reactive particulate mineral compositions for use in making low carbon blended cements and low carbon concrete mixes. The particulate mineral compositions comprise one or more pozzolanic materials and one or more mineral filler materials. Because the particulate mineral compositions can be made so as to be significantly non-hydraulically reactive, they do not lose their beneficial characteristics when exposed to moisture and humidity. As a result, they have essentially limitless shelf life. This permits them to be stored in silos essentially indefinitely until added to concrete as a blended SCM or blended with hydraulic cement to form a blended cement. They can also be particle size optimized relative to each other and/or the hydraulic cement component of concrete and blended cements.

The term “pozzolanic component” includes any of the well-known pozzolanic materials used in concrete and other cementitious compositions. The pozzolanic component is characterized by having a high amorphous silica content and can also contain alumina and iron oxide (preferably, so as to comply with the SAF requirements of ASTM C618). Pozzolanic materials are characterized by their ability to react with excess lime released during cement hydration to form additional hydration products, such as calcium silicate hydrates and calcium aluminate hydrates. Examples of suitable pozzolanic materials include, but are not limited to, fly ash, bottom ash, natural pozzolans, volcanic ash, pumice, silica fume, metakaolin, calcined clay, non-hydraulically reactive metallurgical slags, and ground glass.

Pozzolanic materials can be any material that conforms to the chemical and/or activity index requirements of ASTM C618. In some embodiments, the term “pozzolanic material” includes mineral materials that have a combined silicon dioxide (SiO₂), aluminum oxide (Al₂O₃), and iron oxide (Fe₂O₃) content (or SAF) if at least 50%, at least 60%, at least 70%, at least 80%, or at least 90% and an activity index as determined by ASTM C311 of at least 75%, 80%, 85%, 90%, or 95%.

Mineral filler materials can be any material that does not qualify as a pozzolanic material, such as by having an SAF of less than 50%, 40%, 30%, 20%, or 10% and/or an activity index as determined by ASTM C311 of less than 75%, 65%, 55%, 45%, 35%, 25%, 15%, or 5%. The mineral filler component can include, but is not limited, to mineral materials defined by ASTM C1797 and/or ACI 211-ON.

The non-hydraulically reactive particulate mineral compositions are characterized as having little to no hydraulic reactivity, and thus little to no self-cementing properties when exposed to water. In some embodiments, non-hydraulically reactive particulate mineral compositions can have a calcium oxide (CaO) content from all sources (including latent hydraulic materials and optional supplemental lime) of less than 15%, 12.5%, 10%, 8%, 6%, 5%, 4%, 3%, 2%, or 1% and/or a calcium sulfate content of less than 15%, 12.5%, 10%, 8%, 6%, 5%, 4%, 3%, 2%, or 1%

An example non-hydraulically reactive blended particulate mineral composition for use in making low carbon blended cement or low carbon concrete, comprises:
a pozzolanic component having a first D90; and
a mineral filler component dry blended with the pozzolanic component without intergrinding, the mineral filler component having a second D90 greater than the first D90,
wherein the composition is substantially free of hydraulic cement (e.g., less than 5%, 4%, 3%, 2%, or 1%, or that includes 0%).

Another example non-hydraulically reactive blended particulate mineral composition for use in making low carbon blended cement or low carbon concrete, comprises:
a pozzolanic component having a first D90; and
a mineral filler component dry blended with the pozzolanic component without intergrinding, the mineral filler component having a second D90 greater than the first D90,
wherein the composition contains less than 15%, 12.5%, 10%, 8%, 6%, 5%, 4%, 3%, 2%, or 1% of calcium oxide.

Another example non-hydraulically reactive blended particulate mineral composition for use in making low carbon blended cement or low carbon concrete, comprises:
a pozzolanic component having a first D90; and
a mineral filler component dry blended with the pozzolanic component without intergrinding, the mineral filler component having a second D90 greater than the first D90,
wherein the composition contains less than 15%, 12.5%, 10%, 8%, 6%, 5%, 4%, 3%, 2%, or 1% of calcium sulfate.

An example method of manufacturing non-hydraulically reactive particulate mineral composition for use in making low carbon blended cement and/or low carbon concrete, comprises:
combining a pozzolanic component having a first D90 and a mineral filler component without intergrinding to form the non-hydraulically reactive blended particulate composition, the mineral filler component having a second D90 greater than the first D90,
wherein the composition is free of hydraulic cement.

In some embodiments, the particulate mineral compositions are particle size optimized relative to each other and/or the hydraulic cement component when making concrete or low carbon blended cement in order to maximize the relative contributions of each component, with the pozzolanic component being relative fine to increase or maximize pozzolanic reactivity and the mineral filler being relatively coarse to reduce or minimize water demand while increasing the particle packing density of the particulate components when blended with water to form cement paste. In some embodiments, the pozzolanic component can have greater fineness and/or lower D90 than ordinary Portland cement (OPC) as defined by ASTM C150 and ordinary blended cement (OBC) as defined by ASTM C595, and the mineral filler component can have lower fineness and/or greater D90 than OPC and OBC. The result is a cementitious composition that, when mixed with water, includes cement paste that is optimized relative to the strength, water demand, particle packing density, and other physical and performance criteria.

Because pozzolanic materials are more pozzolanically reactive with increasing fineness (i.e., smaller particle size), they can advantageously have a D90 that is equal to or less than about 45 μm, such as equal to or less than about 40 μm, or equal to or less than about 35 μm, or equal to or less than about 30 μm, or equal to or less than about 27.5 μm, or equal to or less than about 25 μm, or equal to or less than about 22.5 μm, or equal to or less than about 20 μm, or equal to or less than about 17.5 μm, or equal to or less than about 15 μm, or equal to or less than about 12.5 μm, or equal to or less than about 10 μm, or equal to or less than about 7.5 μm, or equal to or less than about 5 μm, or have a D90 within a range defined by any two of the foregoing particle sizes.

The non-hydraulically reactive particulate mineral compositions comprise one or more mineral fillers that are generally not pozzolanically reactive (e.g., including but not limited to mineral fines that comply with ASTM C1797 and/or ACI 211.0N, formerly ACI 211.7R). Examples of suitable mineral fillers, include, but are not limited to, ground limestone powder, quarry fines, rock dust, ground recycled concrete, ground minerals, ground quartz, ground granite, ground basalt, mine tailings, and marble dust. Mineral fillers may also comprise semi-pozzolanic materials that do not meet the requirements of ASTM C618, such as by having a low SAF content and/or low reactivity index. Examples can include non-granulated metallurgical slags, such as steel slag, copper slag, and the like.

Because mineral fillers are not deliberately selected to be pozzolanically reactive, and may not be pozzolanically reactive at any particle size, and because water demand decreases with decreasing fineness (i.e., larger particle size), they can advantageously have a D90 that is greater than about 45 μm, such as equal to or greater than about 50 μm, equal to or greater than about 55 μm, equal to or greater than about 60 μm, equal to or greater than about 65 μm, equal to or greater than about 70 μm, equal to or greater than about 75 μm, equal to or greater than about 80 μm, equal to or greater than about 90 μm, equal to or greater than about 100 μm, equal to or greater than about 110 μm, equal to or greater than about 120 μm, equal to or greater than about 135 μm, equal to or greater than about 150 μm, equal to or greater than about 175 μm, equal to or greater than about 200 μm, equal to or greater than about 225 μm, equal to or greater than about 250 μm, equal to or greater than about 275 μm, equal to or greater than about 300 μm, or a D90 within a range defined by any two of the foregoing D90 values. The D90 of the mineral filler is advantageously less than about 1000 μm, less than about 750 μm, less than about 500 μm, less than about 400 μm, less than about 300 μm, less than about 250 μm, less than about 200 μm, less than about 150 μm, less than about 125 μm, less than about 100 μm, less than about 90 μm, less than about 80 μm, less than about 70 μm, less than about 60 μm, or less than about 50 μm, or a D90 within a range defined by any two of the foregoing D90 values.

The mineral filler can have a D50 of less than about 70 μm, such as equal to or less than about 60 μm, equal to or less than about 50 μm, equal to or less than about 40 μm, equal to or less than about 40 μm, or equal to or less than about 35 μm, or equal to or less than about 30 μm, or equal to or less than about 25 μm, or equal to or less than about 20 μm and equal to or greater than about 10 μm, or equal to or greater than about 15 μm, or equal to or greater than about 20 μm, or equal to or greater than about 25 μm, or a D50 within a range defined by any two of the foregoing D50 values.

The mineral filler can have a D10 of less than about 30 μm, such as equal to or less than about 25 μm, or equal to or less than about 20 μm, or equal to or less than about 17.5 μm, or equal to or less than about 15 μm, or equal to or less than about 12.5 μm, or equal to or less than about 10 μm, or equal to or less than about 7.5 μm, or equal to or less than about 5 μm and equal to or greater than about 1 μm, or equal to or greater than about 2 μm, or equal to or greater than about 3 μm, or equal to or greater than about 4 μm, or equal to or greater than about 5 μm, or a D10 within a range defined by any two of the foregoing D50 values.

The ratio of the D90 to the D10 (D90/D10) of the mineral filler component can be equal to or greater than 3.7, or equal to or greater than 4, or equal to or greater than 4.5, or equal to or greater than 5, or equal to or greater than 6, or equal to or greater than 8, or equal to or greater than 10, or equal to or greater than 12.5, or equal to or greater than 15, or within a range defined by any two of the foregoing D90/D10 values.

In some embodiments, the ratio of the D90 of the mineral filler component to the D90 of the pozzolanic component can be about 1.05:1, about 1.1:1, or about 1.25:1, or about 1.5:1, or about 1.75:1, or about 2:1, or about 2.5:1, or about 3:1, or about 4:1, or about 5:1, or about 6:1, or about 7:1, or about 8:1, or about 9:1, or about 10:1, or within a range defined by any two of the foregoing ratios.

In some embodiments, the ratio of the D50 of the mineral filler component to the D50 of the pozzolanic component can be about 1.05:1, about 1.1:1, or about 1.25:1, or about 1.5:1, or about 1.75:1, or about 2:1, or about 2.5:1, or about 3:1, or about 4:1, or about 5:1, or about 6:1, or about 7:1, or about 8:1, or about 9:1, or about 10:1, or within a range defined by any two of the foregoing ratios.

In some embodiments, the ratio of the D10 of the mineral filler component to the D10 of the pozzolanic component can be about 1.05:1, about 1.1:1, or about 1.25:1, or about 1.5:1, or about 1.75:1, or about 2:1, or about 2.5:1, or about 3:1, or about 4:1, or about 5:1, or about 6:1, or about 7:1, or about 8:1, or about 9:1, or about 10:1, or within a range defined by any two of the foregoing ratios.

In some embodiments, the non-hydraulically reactive particulate mineral compositions can contain equal amounts by weight or volume of the pozzolanic component and mineral filler component. Depending on the desired resulting blended cement when combined with hydraulic cement, the non-hydraulically reactive particulate mineral composition may include a greater or lesser quantity of the pozzolanic component than the mineral filler component. In some embodiments, particularly where the pozzolanic component is finer than OPC and the mineral filler component is coarser than OPC, the non-hydraulically reactive particulate mineral compositions can include a greater quantity of the mineral filler component than the pozzolan component. This is because there are practical constraints to how much additional fine particles can be added to OPC, i.e., so as to “fit” within the finer section of the overall particle size distribution. On the other hand, because the size gap between the largest OPC particles and smallest aggregate particles is relatively large, there is more “room” to add a greater quantity of the mineral filler component.

In view of the foregoing, the ratio of the mineral filler component to the pozzolanic component, expressed by weight or by volume, can be about 30:70, or about 40:60, or about 50:50 (e.g., 49:50, 49.5:50.5, or 49.9:50.1), or about 55:45, or about 60:40, or about 65:35, or about 70:30, or about 75:25, or about 80:20, or about 90:10, or within a range define by any two of the foregoing ratios. In the event that ASTM C1697 were to be modified to permit blended SCMs that contain ground limestone or other mineral filler, the ratio of the mineral filler component to the pozzolanic component can be selected to comply with such modified ASTM C1697.

In order for the non-hydraulically reactive particulate mineral compositions to remain stable in the presence of moisture and not be significantly hydraulically reactive, the non-hydraulically reactive particulate mineral compositions can have a total alkali and alkaline earth metal oxide and hydroxide content of less than 10%, or less than about 9%, or less than about 8%, or less than about 7%, or less than about 6%, or less than about 5%, or less than about 4%, or less than about 3%, or less than about 2%, or less than about 1%. Moreover, even if the pozzolan contains a higher quantity of lime, such as class C fly ash, it may not be harmful, and it may in fact be beneficial, for the at least some of the lime to absorb moisture and react with carbon dioxide in the air to form calcium carbonate.

The terms “hydraulic cement” and “cement” shall include Portland cement, cements defined by ASTM C150 (Types I-V), blended cements defined by ASTM C595 (IL, IP, IS, and IT) and similar materials that contain one or more of the four clinker minerals: C₃S (tricalcium silicate), C₂S (dicalcium silicate), C₃A (tricalcium aluminate), and C₄AF (tetracalcium aluminoferrite). Other examples of hydraulic cement include white cement, calcium aluminate cement, high-alumina cement, magnesium silicate cement, magnesium oxychloride cement, oil well cements (e.g., Type VI, VII and VIII), magnesite cements, and combinations of these. Ground granulated blast-furnace slag (GGBFS) and other slags that include one or more clinker minerals may also function as hydraulic cement but are often considered to have latent hydraulic properties so as to require activation, such as using alkali salts, lime, or sulfate.

In some embodiments, the term “pozzolan” means glassy silicas and aluminosilicates that are pozzolanically reactive in the presence of free lime released during hydration of Portland cement. Examples include, but are not limited to, fly ash, finely ground bottom ash, finely ground metallurgical slag, silica fume, metakaolin, volcanic ash, natural pozzolan, trass, calcined shale, calcined clay, and ground glass.

The term “mineral filler” means any particulate mineral material that is not hydraulically reactive and may have limited to no pozzolanic reactivity. Examples include, but are not limited to, waste aggregate particles or fines, waste or manufactured limestone fines, quarry fines, limestone powder, ground quartz, granite fines, waste minerals from crushed rock, waste minerals from sand, stone dust, rock dust, marble dust, mine tailings, pulverized bottom ash, pulverized non-cementitious metallurgical slag, ground recycled concrete, waste or pulverized shale from shale oil extraction, waste or pulverized sand from tar sand extraction, precipitated calcium carbonate, precipitated magnesium carbonate, and red mud.

In some embodiments, the pozzolanic component comprises at least two pozzolans blended without intergrinding selected from the group consisting of fly ash, finely ground bottom ash, finely ground metallurgical slag, silica fume, metakaolin, volcanic ash, natural pozzolan, trass, calcined shale, calcined clay, ground glass, and combinations thereof. In other embodiments, the pozzolanic component comprises at least two pozzolans interground together selected from the group consisting of fly ash, finely ground bottom ash, finely ground metallurgical slag, silica fume, metakaolin, volcanic ash, natural pozzolan, trass, calcined shale, calcined clay, ground glass, and combinations thereof. In still other embodiments the pozzolanic component comprises at least one pozzolan interground with a mineral filler

OPC, OBC, or other hydraulic cement can be blended with the non-hydraulically reactive particulate mineral composition prior to or during the manufacture of concrete. In some embodiments, the non-hydraulically reactive particulate mineral composition can be used to manufacture concrete by blending it with OPC, OBC, or other hydraulic cement, aggregates, water, and optional chemical admixtures. When kept free of hydraulic cement, the non-hydraulically reactive particulate mineral composition can have essentially indefinite shelf-life, which is a major advancement over typical blended cements.

An example method of manufacturing low carbon blended cement comprising combining a non-hydraulically reactive blended particulate composition with hydraulic cement without intergrinding. In some embodiments, the hydraulic cement is selected from Portland cement and ground granulated blast furnace slag.

An example method of manufacturing low carbon concrete comprises:
combining the non-hydraulically reactive blended particulate mineral composition, hydraulic cement, aggregate, and water to form a fresh concrete mix;
positioning the fresh concrete mix in a desired shape; and
allowing the fresh concrete mix to harden to form hardened concrete.

Another important advantage of the non-hydraulically reactive particulate mineral compositions is that they can be stored in a single silo at a concrete manufacturing facility. This eliminates the need to have separate silos for the pozzolan and mineral filler components, thereby facilitating incorporation of the non-hydraulically reactive particulate mineral compositions into existing concrete manufacturing plants. Most concrete plants have dedicated silos for cement, fly ash or other pozzolan, and, in some regions, ground granulated blast furnace slag. However, an impediment to incorporating mineral fillers in concrete is the need to retrofit existing concrete plants with an extra silo. However, the non-hydraulically reactive particulate mineral composition can be placed into an existing silo at a concrete plant, such as a dedicated pozzolan silo. The only modification would be the modification of concrete mix designs to account for the presence of the mineral filler and its effect on slump and rheology in freshly mixed concrete and the strength of hardened concrete.

Another advantage of the non-hydraulically reactive particulate mineral compositions is that they can significantly reduce the amount of pozzolan that would otherwise be required to yield concrete having desired workability and strength. Pozzolans often serve the dual purpose of reducing cement content while maintaining or increasing overall cement paste content in concrete in order to maintain desired workability and strength. Sometimes excessive quantities of cement and/or SCMs are used simply to maintain a desired cement paste volume (e.g., for workability). However, non-hydraulically reactive particulate mineral compositions can maintain or increase paste volume in concrete so as to maintain desired workability and strength, while permitting even greater reductions in cement content compared to conventional concrete made using cement and pozzolans. Moreover, incorporating a mineral filler can permit the reductions of both cement content and pozzolan content compared to conventional concrete, while maintaining or increasing cement paste content.

It is currently known that fly ash is becoming scarce as coal fired power plants are being phased out. As a result, companies are now stockpiling fly ash for use over time, which will increase its cost and value. Blending scarce fly ash with a mineral filler component yields a non-hydraulically reactive particulate mineral composition that can provide concrete with the desired benefits of fly ash, while using less pozzolan per unit of concrete. This will have the effect of extending the supply of fly ash or other pozzolans, which are typically much more expensive than mineral fillers.

In some embodiments, the non-hydraulically reactive particulate mineral composition can be dry blended with OPC, OBC, or other hydraulic cement, with the understanding that the resulting blended cement will then have limited shelf life typical of OPC, OBC, and other hydraulic cements. For example, the non-hydraulically reactive particulate mineral composition can be stored indefinitely until such time as it may be desired to make a blended cement comprising hydraulic cement, pozzolan, and mineral filler. The non-hydraulically reactive particulate mineral composition can be manufactured at a dedicated blending facility and stored indefinitely until such time as it may be desired to make a blended cement that can be delivered to concrete manufacturing plants.

The pozzolan and mineral filler components are typically manufactured separately and then dry blended to form the non-hydraulically reactive particulate mineral composition. In this way, the PSD of each component can be controlled. For example, a pozzolan can be processed by grinding, air classification, and/or calcining to form the pozzolan component. The mineral filler can be processed by grinding to a coarser PSD in a separate process and then dry blended with the pozzolan.

The non-hydraulically reactive particulate mineral composition can further include one or more chemical admixtures and additives known in the art, such as one or more water reducers, accelerators, hydration stabilizers, and air entraining agents. Water reducers include low range, mid range, and high range water reducers, including superplasticizers. Admixtures and additives can be added to the non-hydraulically reactive particulate mineral composition at any stage of manufacture, such as when grinding the pozzolan and/or mineral filler and/or when dry-blending with the pozzolan and mineral filler components. Because the hydraulically reactive particulate mineral composition does not become deactivated when exposed to moisture, liquid admixtures can be added to the grinding process and used as a grinding aid, with the water being driven off by evaporation as a result of heat generated by the grinding process. Typical amine grinding aids, such astriethanolamine (TEA) and triisopropanolamine (TIPA), can be used when grinding a pozzolan and/or mineral filler component. In some embodiments, the particulate mineral compositions can be free of plant-based materials so as to consist or consist essentially of only inorganic mineral-based components. Chemical admixtures, including water reducing agents that include lignosulfonates and viscosity-modifying agents that include cellulosic ethers, are not plant-based bio-based fillers or materials but chemically modified substances.

The pozzolan and mineral filler components can be processed by equipment known in the art. Example grinding equipment includes a rod mill, vertical roller mill (“VRM”), high pressure grinding roll, hammer mill, or ball mill. Air classifiers can be used to further control particle size, including as stand-alone equipment or incorporated within a grinding circuit.

The non-hydraulically reactive particulate mineral composition can be used to replace a portion of OPC, OBC, or other hydraulic cement in concrete, including site blends of hydraulic cement and SCM, interground blends, and other cements known in the art. They can be used to make concrete, ready mix concrete, bagged concrete, bagged cement, mortar, bagged mortar, grout, bagged grout, molding compositions, or other fresh or dry cementitious compositions known in the art. Non-hydraulically reactive particulate mineral compositions can be used to manufacture concrete and other cementitious compositions that include a hydraulic cement binder, water and aggregate, such as fine and coarse aggregates. Mortar typically includes cement, water, sand, and lime and is sufficiently stiff to support the weight of a brick or concrete block. Oil well cement refers to cementitious compositions continuously blended and pumped into a well bore. Grout is used to fill in spaces, such as cracks or crevices in concrete structures, spaces between structural objects, and spaces between tiles. Molding compositions are used to manufacture molded or cast objects, such as pots, troughs, posts, walls, floors, fountains, ornamental stone, and the like.

Water is both a reactant and rheology modifier that permits a fresh cementitious composition to flow or be molded into a desired configuration. Hydraulic cement reacts with water, binds the other solid components together, and is most responsible for early strength development and can contribute to later strength development. Blends with high PPD have reduced void space, which reduces water demand and increases workability for a given quantity of water.

An example of another blended particulate composition for use in making low carbon blended cement or low carbon concrete includes a blend of ground granulated blast furnace slag having a first D90 and a mineral filler component dry blended with the ground granulated blast furnace slag without intergrinding, the mineral filler component having a second D90 greater than the first D90, wherein the composition is free of Portland cement. This blended particulate composition may further comprise at least pozzolan and/or mineral filler blended with the ground granulated blast furnace slag. The blended particulate composition can further be blended with Portland cement to make low carbon blended cement or blended with Portland cement, aggregates, water, and optional admixtures to make low carbon concrete.

### EXAMPLES

Concrete compositions were manufactured by blending together Portland cement, a pozzolan, a mineral filler, aggregates, water, and admixtures. In some cases, the pozzolan and mineral filler components were initially dry blended to form a non-hydraulically reactive particulate mineral composition, which was then combined with OPC, aggregates, water, and admixtures to form fresh concrete mixes. In other cases, the non-hydraulically reactive particulate mineral composition was dry blended with OPC to form a dry blended low carbon cement to ensure good dispersion just prior to mixing the dry blended low carbon cement with water, aggregates, and admixtures to make fresh concrete mixes. The fresh concrete mixes were cast into cylindrical molds and tested for strength.

### Examples 1-10

Non-hydraulically reactive particulate mineral compositions were prepared and then used to make a series of low carbon precast concrete compositions. The precast concrete compositions were prepared using dry blends of natural pozzolan (Geofortis) and ground limestone (Graymont) prepared by mixing without intergrinding. The natural pozzolan reportedly had a D90 of less than 45 μm (about 35-40 μm), and the ground limestone reportedly had a D90 greater than 45 μm (about 70-90 μm). The Portland cement was ASTM C595 IL cement from Holcim, Devil's Slide, Utah.

The non-hydraulically reactive particulate mineral compositions were added to a laboratory size rotary mixer as a subcomponent and mixed with Portland cement, water, aggregates, and various chemical admixtures (i.e., air entrainer, water reducers, etc.) to obtain freshly mixed precast concrete compositions. The freshly mixed precast concrete compositions were placed into 4×8 inch test cylinders, which were capped, allowed to harden, and taken to CMT Technical Services (West Vally City, Utah) for storage in a curing chamber and testing at various time intervals.

Tables 1 and 2 show complete mix designs (based on 1 cubic yard, exclusive of admixtures) used to prepare low carbon precast concrete compositions using the non-hydraulically reactive particulate mineral composition as a subcomponent.

TABLE 1

| Components (lb/yd³) | Example # (Mix ID) | | | | |
|---|---|---|---|---|---|
| Compressive Strength | 1 (952) | 2 (952L) | 3 (952P) | 4 (952NP) | 5 (952P2) |
| ASTM C595 IL cement | 570 | 570 | 570 | 570 | 570 |
| Natural Pozzolan | 150 | 150 | 150 | 162 | 160 |
| Limestone Powder | 224 | 216 | 222 | 212 | 212 |
| Type S Lime | 0 | 8 | 0 | 0 | 0 |
| Plaster of Paris | 0 | 0 | 2 | 2 | 2 |
| Coarse Aggregate (¾″) | 1095 | 1095 | 1095 | 1095 | 1095 |
| Pea Gravel | 247 | 247 | 247 | 247 | 247 |
| Fine Aggregate (sand) | 1071 | 1059 | 1070 | 1069 | 1032 |
| Water | 292 | 296 | 292 | 292 | 292 |
| 1-day (psi/MPa) | | | 3255/22.4 | | |
| 3-day (psi/MPa) | 4875/33.6 | 4750/32.8 | 5465/37.7 | | 5490/37.9 |
| 7-day (psi/MPa) | 5620/33.6 | 5340/36.8 | 6325/43.6 | | 7335/50.6 |
| 28-day (psi/MPa) | 6555/45.2 | 6665/46.0 | 7900/54.5 | | 8875/61.2 |
| 56-day (psi/MPa) | 7425/51.2 | 7405/51.1 | | | |

TABLE 2

| Components (lb/yd³) | Example # (Mix ID) | | | | |
|---|---|---|---|---|---|
| Compressive Strength | 6 (103) | 7 (103P) | 8 (103P1) | 9 (103P2) | 10 (753P) |
| ASTM C595 IL cement | 547 | 546 | 547 | 547 | 395.2 |
| Natural Pozzolan | 198 | 216 | 198 | 198 | 252.27 |
| Limestone Powder | 245 | 225 | 234 | 243 | 130 |
| Type S Lime | 0 | 0 | 0 | 0 | 0 |
| Plaster of Paris | 0 | 3 | 2 | 2 | 2.54 |
| Coarse Aggregate (¾″) | 1090 | 1095 | 1088 | 1090 | 1550 |
| Pea Gravel | 232 | 247 | 230 | 231 | 0 |
| Fine Aggregate (sand) | 1080 | 1079 | 1081 | 1080 | 1104 |
| Water | 297 | 288 | 301.5 | 297 | 292 |
| 1-day (psi/MPa) | | 4120 | | 3175/21.9 | |
| 2-day (psi/MPa) | | | | | 1790/12.3 |
| 3-day (psi/MPa) | | 6270/43.2 | 4375/30.2 | 5570/38.4 | 3700/25.5 |
| 7-day (psi/MPa) | | 7545/52.0 | 5340/36.8 | 6570/45.3 | 5110/35.2 |
| 28-day (psi/MPa) | | 9855/67.9 | 7235/49.9 | 8750/60.3 | 7390/51.0 |
| 56-day (psi/MPa) | | | | | 8360/57.6 |
| 91-day (psi/MPa) | | | | | 9940/68.5 |

### Examples 11-20

Non-hydraulically reactive particulate mineral compositions were prepared and then used to make a series of low carbon ready mix concrete compositions. The ready mix concrete compositions were prepared using dry blends of natural pozzolan (Geofortis) and ground limestone (Graymont) prepared by mixing without intergrinding. The natural pozzolan reportedly had a D90 of less than 45 μm (about 35-40 μm), and the ground limestone reportedly had a D90 greater than 45 μm (about 70-90 μm).

The non-hydraulically reactive particulate mineral compositions were added to a laboratory size rotary mixer as a subcomponent and mixed with Portland cement, water, aggregates, and various chemical admixtures (i.e., air entrainer, water reducers, etc.) to obtain freshly mixed ready mix concrete compositions. The freshly mixed ready mix concrete compositions were placed into 4×8 inch test cylinders, which were capped, allowed to harden, and taken to CMT Technical Services (West Vally City, Utah) for storage in a curing chamber and testing at various time intervals. The Portland cement was ASTM C595 IL cement from Holcim, Devil's Slide, Utah.

Tables 3 and 4 show complete mix designs (based on 1 cubic yard, exclusive of admixtures) used to prepare low carbon ready mix concrete compositions using the non-hydraulically reactive particulate mineral composition as a subcomponent.

TABLE 3

| Components (lb/yd³) | Example # (Mix ID) | | | | |
|---|---|---|---|---|---|
| Compressive Strength | 11 (1-3000) | 12 (1-2100) | 13 (2-2100) | 14 (3-2100) | 15 (1-4000) |
| ASTM C595 IL cement | 325 | 390 | 390 | 390 | 415 |
| Natural Pozzolan | 100 | 102 | 105 | 105 | 78 |
| Limestone Powder | 150 | 144 | 141 | 141 | 150 |
| Type S Lime | 0 | 0 | 0 | 0 | 0 |
| Plaster of Paris | 0 | 0 | 0 | 0 | 0 |
| Coarse Aggregate (¾″) | 1520 | 1720 | 1720 | 1720 | 1720 |
| Fine Aggregate (sand 1) | 700 | 0 | 0 | 0 | 0 |
| Fine Aggregate (sand 2) | 710 | 1155 | 1150 | 1150 | 1117 |
| Water | 270 | 252 | 252 | 252 | 264 |
| 3-day (psi/MPa) | 1900/13.1 | 3550/24.5 | 3195/22.0 | | 2610/18.0 |
| 7-day (psi/MPa) | 2610/18.0 | 4330/29.9 | 3625/25.0 | 3810/26.3 | 3010/20.8 |
| 28-day (psi/MPa) | 3865/26.6 | 5545/38.2 | 4885/33.7 | 5095/35.1 | 4045/27.9 |
| 56-day (psi/MPa) | 4580/31.6 | 6240/43.0 | 5630/38.8 | 5510/38.0 | 4220/29.1 |

TABLE 4

| Components (lb/yd³) | Example # (Mix ID) | | | | |
|---|---|---|---|---|---|
| Compressive Strength | 16 (2-4000) | 17 (3-4000) | 18 (4-4000) | 19 (1-5000) | 20 (2-5000) |
| ASTM C595 IL cement | 399 | 399 | 388.2 | 483 | 448 |
| Natural Pozzolan | 99 | 99 | 109.8 | 98 | 126 |
| Limestone Powder | 160 | 154 | 156 | 182 | 182 |
| Type S Lime | 0 | 6 | 0 | 0 | 0 |
| Plaster of Paris | 0 | 0 | 0 | 0 | 0 |
| Coarse Aggregate (¾″) | 1730 | 1730 | 1730 | 1650 | 1661 |
| Fine Aggregate (sand 1) | 0 | 0 | 0 | 320 | 330 |
| Fine Aggregate (sand) | 1123 | 1122 | 1118 | 746 | 740 |
| Water | 250.2 | 250.2 | 250.2 | 266 | 255.5 |
| 3-day (psi/MPa) | 3460/23.9 | 2670/18.4 | 3660/25.2 | 4480/30.9 | 4670/32.2 |
| 7-day (psi/MPa) | 4065/28.0 | 3150/21.7 | 4165/28.7 | 5105/35.2 | 5215/36.0 |
| 28-day (psi/MPa) | 5420/37.4 | 4145/28.6 | 5975/41.2 | 6525/45.0 | 7155/49.3 |
| 56-day (psi/MPa) | 5665/39.1 | 4565/31.5 | 6555/45.2 | 7320/50.5 | 7865/54.2 |

### Examples 21-30

Non-hydraulically reactive particulate mineral compositions were prepared and then used to make a series of low carbon ready mix concrete compositions. The ready mix concrete compositions were prepared using dry blends of Type F fly ash (Jim Bridger, Wyoming or Lafarge Canada) and ground limestone (Graymont) prepared by mixing without intergrinding. The fly ash reportedly had a D90 of less than 45 μm (about 35-40 μm), and the ground limestone reportedly had a D90 greater than 45 μm (about 70-90 μm). The Portland cement was ASTM C595 IL cement from Ash Grove, Leamington, Utah, Lafarge, Exshaw, Alberta, or Holcim, Devil's Slide, Utah.

The non-hydraulically reactive particulate mineral compositions were added to a laboratory size rotary mixer as a subcomponent and mixed with Portland cement, water, aggregates, and various chemical admixtures (i.e., air entrainer, water reducers, etc.) to obtain freshly mixed ready mix concrete compositions. The freshly mixed ready mix concrete compositions of Examples 21-25 and 29 were placed into 4×8 inch test cylinders, which were capped, allowed to harden, and taken to CMT Technical Services (West Vally City, Utah) for storage in a curing chamber and testing at various time intervals. Examples 26-28 and 30 were mixed and tested by CMT Technical Services.

Tables 5 and 6 shows complete mix designs (based on 1 cubic yard, exclusive of admixtures) used to prepare low carbon ready mix concrete compositions using the non-hydraulically reactive particulate mineral composition as a subcomponent.

TABLE 5

| Components (lb/yd³) | Example # (Mix ID) | | | | |
|---|---|---|---|---|---|
| Compressive Strength | 21 (RAE1) | 22 (RAE2) | 23 (RAE3) | 24 (RLF1) | 25 (RLF2) |
| ASTM C595 IL cement | 371.2 | 371.2 | 380 | 394.8 | 338.4 |
| Fly Ash | 104.4 | 104.4 | 110 | 112.8 | 141 |
| Limestone Powder | 145 | 145 | 150 | 124.08 | 172.02 |
| Type S Lime | 0 | 0 | 0 | 0 | 0 |
| Plaster of Paris | 0 | 0 | 0 | 0 | 2.82 |
| Coarse Aggregate (¾″) | 1539 | 1539 | 1639 | 1825 | 1825 |
| Pea Gravel | 330 | 330 | 150 | 0 | 0 |
| Fine Aggregate (sand) | 1144 | 1144 | 1218 | 1340 | 1169 |
| Water | 250 | 250 | 252 | 265 | 245 |
| 3-day (psi/MPa) | 3980/27.4 | 3335/23.0 | 3975/27.4 | 2565/17.7 | 3040/21.0 |
| 7-day (psi/MPa) | 4910/33.9 | 4340/29.9 | 4660/32.1 | 3650/25.2 | 3325/22.9 |
| 28-day (psi/MPa) | 6485/44.7 | 5710/39.4 | 5670/39.1 | 5550/38.3 | 5310/36.6 |
| 56-day (psi/MPa) | 7325/50.5 | 6645/45.8 | 6650/45.9 | 6020/41.5 | 6395/44.1 |

TABLE 6

| Components (lb/yd³) | Example # (Mix ID) | | | | |
|---|---|---|---|---|---|
| Compressive Strength | 26 (3-5000) | 27 (4-5000) | 28 (5-5000) | 29 (1-4500) | 30 (6-4000) |
| ASTM C595 IL cement | 481.5 | 481.5 | 481.5 | 425 | 391 |
| Fly Ash | 127.5 | 127.5 | 127.5 | 80 | 104 |
| Limestone Powder | 182 | 182 | 182 | 165 | 150 |
| Type S Lime | 0 | 0 | 0 | 0 | 0 |
| Plaster of Paris | 0 | 0 | 0 | 0 | 0 |
| Coarse Aggregate (¾″) | 1628 | 1633 | 1623 | 1760 | 1761 |
| Pea Gravel | 0 | 0 | 0 | 0 | 0 |
| Fine Aggregate (sand) | 1041 | 1057 | 1024 | 1150 | 1137 |
| Water | 267 | 258 | 278 | 245.7 | 250.7 |
| 3-day (psi/MPa) | 4155/28.6 | 4905/33.8 | 4290/29.6 | 2805/19.3 | 3375/23.3 |
| 7-day (psi/MPa) | 5435/37.5 | | 5540/38.2 | 4030/27.8 | 4240/29.2 |
| 28-day (psi/MPa) | 6940/47.8 | 8225/56.7 | 7283/50.2 | 5370/37.0 | 5270/36.3 |
| 56-day (psi/MPa) | 7840/54.1 | 9340/64.4 | 8300/57.2 | 6790/46.8 | 6190/42.7 |

### Example 31

Any of the foregoing examples is modified by including silica fume in addition to or instead at least part of the natural pozzolan or fly ash.

### Example 32

Any of the foregoing examples is modified by including calcined clay in addition to or instead at least part of the natural pozzolan, fly ash, or silica fume.

### Example 33

Any of the foregoing examples is modified by including ground glass in addition to or instead at least part of the natural pozzolan, fly ash, silica fume, or calcined clay.

### Example 34

Any of the foregoing examples is modified by including ground granulated blast furnace slag (GGBFS) in addition to or instead at least part of the natural pozzolan, fly ash, silica fume, calcined clay, or ground glass.

### Example 35

Any of the foregoing examples is modified by including mine tailings in addition to or instead at least part of the limestone powder.

### Example 36

Any of the foregoing examples is modified by including ground recycled concrete in addition to or instead at least part of the limestone powder or mine tailings.

### Example 37

Any of the foregoing examples is modified by including ground siliceous aggregate fines in addition to or instead at least part of the limestone powder, mine tailings, or ground recycled concrete.

### Example 38

Any of the foregoing examples is modified by including supplemental lime or supplemental sulfate in the blended particulate composition.

### Example 39

Any of the foregoing examples is modified by including at least one admixture in the blended particulate composition selected form water reducers, accelerators, hydration stabilizers, and air entraining agents.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A non-hydraulically reactive blended particulate composition for use in making low carbon blended cement or low carbon concrete, comprising:
a pozzolanic component having a first D90; and
a mineral filler component dry blended with the pozzolanic component without intergrinding, the mineral filler component having a second D90 greater than the first D90,
wherein the composition is free of hydraulic cement.

2. The non-hydraulically reactive blended particulate composition of claim 1, wherein the pozzolanic component comprises at least one pozzolan selected from the group consisting of fly ash, finely ground bottom ash, finely ground metallurgical slag, silica fume, metakaolin, volcanic ash, natural pozzolan, trass, calcined shale, calcined clay, ground glass, and combinations thereof.

3. The non-hydraulically reactive blended particulate composition of claim 1, wherein the pozzolanic component comprises at least two pozzolans blended without intergrinding selected from the group consisting of fly ash, finely ground bottom ash, finely ground metallurgical slag, silica fume, metakaolin, volcanic ash, natural pozzolan, trass, calcined shale, calcined clay, ground glass, and combinations thereof.

4. The non-hydraulically reactive blended particulate composition of claim 1, wherein the pozzolanic component comprises at least two pozzolans interground together selected from the group consisting of fly ash, finely ground bottom ash, finely ground metallurgical slag, silica fume, metakaolin, volcanic ash, natural pozzolan, trass, calcined shale, calcined clay, ground glass, and combinations thereof.

5. The non-hydraulically reactive blended particulate composition of claim 1, wherein the pozzolanic component comprises at least one pozzolan interground with a mineral filler.

6. The non-hydraulically reactive blended particulate composition of claim 1, wherein the mineral filler component is selected from the group consisting of waste aggregate particles or fines, waste or manufactured limestone fines, quarry fines, limestone powder, granite fines, waste minerals from crushed rock, waste minerals from sand, stone dust, rock dust, marble dust, mine tailings, pulverized bottom ash, pulverized non-cementitious metallurgical slag, ground recycled concrete, waste or pulverized shale from shale oil extraction, waste or pulverized sand from tar sand extraction, and combinations thereof.

7. The non-hydraulically reactive blended particulate composition of claim 1, wherein the composition is free of plant-based bio-based fillers.

8. The non-hydraulically reactive blended particulate composition of claim 1, wherein the D90 of the pozzolanic component is equal to or less than about 45 μm, equal to or less than about 40 μm, equal to or less than about 35 μm, equal to or less than about 30 μm, equal to or less than about 27.5 μm, equal to or less than about 25 μm, equal to or less than about 22.5 μm, equal to or less than about 20 μm, equal to or less than about 17.5 μm, equal to or less than about 15 μm, equal to or less than about 12.5 μm, equal to or less than about 10 μm, equal to or less than about 7.5 μm, or equal to or less than about 5 μm, or has a D90 within a range defined by any two of the foregoing.

9. The non-hydraulically reactive blended particulate composition of claim 1, wherein the D90 of the mineral filler component is equal to or greater than about 45 μm, equal to or greater than about 50 μm, equal to or greater than about 55 μm, equal to or greater than about 60 μm, equal to or greater than about 65 μm, equal to or greater than about 70 μm, equal to or greater than about 75 μm, equal to or greater than about 80 μm, equal to or greater than about 90 μm, equal to or greater than about 100 μm, equal to or greater than about 110 μm, equal to or greater than about 120 μm, equal to or greater than about 135 μm, equal to or greater than about 150 μm, equal to or greater than about 175 μm, equal to or greater than about 200 μm, equal to or greater than about 225 μm, equal to or greater than about 250 μm, equal to or greater than about 275 μm, equal to or greater than about 300 μm and less than about 1000 μm, less than about 750 μm, less than about 500 μm, less than about 400 μm, or has a D90 within a range defined by any two of the foregoing.

10. The non-hydraulically reactive blended particulate composition of claim 1, wherein the mineral filler component has a D50 of less than about 70 μm and/or a D10 of less than about 30 μm.

11. The non-hydraulically reactive blended particulate composition of claim 1, characterized in that:
the ratio of the D90 of the mineral filler component to the D90 of the pozzolanic component is about 1.05:1, about 1.1:1, about 1.25:1, about 1.5:1, about 1.75:1, about 2:1, about 2.5:1, about 3:1, about 4:1, about 5:1, about 6:1, about 7:1, about 8:1, about 9:1, or about 10:1, or a ratio within a range define by any two of the foregoing; and/or
the ratio of the D50 of the mineral filler component to the D50 of the pozzolanic component is about 1.05:1, about 1.1:1, about 1.25:1, about 1.5:1, about 1.75:1, about 2:1, about 2.5:1, about 3:1, about 4:1, about 5:1, about 6:1, about 7:1, about 8:1, about 9:1, or about 10:1, or a ratio within a range define by any two of the foregoing; and/or
the ratio of the D10 of the mineral filler component to the D10 of the pozzolanic component is about 1.05:1, about 1.1:1, about 1.25:1, about 1.5:1, about 1.75:1, about 2:1, about 2.5:1, about 3:1, about 4:1, about 5:1, about 6:1, about 7:1, about 8:1, about 9:1, or about 10:1, or a ratio within a range define by any two of the foregoing.

12. The non-hydraulically reactive blended particulate composition of claim 1, wherein a ratio of the mineral filler component to the pozzolanic component, by weight or by volume, is about 30:70, about 35:65, about 40:60, about 45:55, about 50:50, about 55:45, about 60:40, about 65:35, about 70:30, about 75:25, about 80:20, or about 90:10, or a ratio within a range define by any two of the foregoing.

13. The non-hydraulically reactive blended particulate composition of claim 1, wherein the non-hydraulically reactive blended particulate composition remains stable in the presence of moisture and are not significantly hydraulically reactive, wherein the non-hydraulically reactive blended particulate composition has a total alkali and alkaline earth metal oxide and hydroxide content of less than 10%, or less than about 9%, or less than about 8%, or less than about 7%, or less than about 6%, or less than about 5%, or less than about 4%, or less than about 3%, or less than about 2%, or less than about 1%.

14. A method of manufacturing a non-hydraulically reactive blended particulate composition for use in making low carbon blended cement or low carbon concrete, comprising:
dry blending a pozzolanic component having a first D90 and a mineral filler component without intergrinding to form the non-hydraulically reactive blended particulate composition, the mineral filler component having a second D90 greater than the first D90,
wherein the composition is free of hydraulic cement.

15. A method of manufacturing low carbon blended cement comprising combining the non-hydraulically reactive blended particulate composition of claim 1 with hydraulic cement without intergrinding.

16. The method of claim 15, wherein the hydraulic cement is selected from Portland cement and ground granulated blast furnace slag.

17. A method of manufacturing low carbon concrete, comprising
combining the non-hydraulically reactive blended particulate composition of claim 1 with hydraulic cement, aggregate, and water to form a fresh concrete mix;
positioning the fresh concrete mix in a desired shape; and
allowing the fresh concrete mix to harden to form hardened concrete.

18. A blended particulate composition for use in making low carbon blended cement or low carbon concrete, comprising:
ground granulated blast furnace slag having a first D90; and
a mineral filler component dry blended with the ground granulated blast furnace slag without intergrinding, the mineral filler component having a second D90 greater than the first D90,
wherein the composition is free of Portland cement.

19. The blended particulate composition of claim 18, further comprising at least one pozzolan selected from the group consisting of fly ash, finely ground bottom ash, finely ground metallurgical slag, silica fume, metakaolin, volcanic ash, natural pozzolan, trass, calcined shale, calcined clay, ground glass, and combinations thereof.

20. A method of manufacturing low carbon blended cement comprising combining the blended particulate composition of claim 18 with Portland cement without intergrinding.
